(19) United States
(12) Patent Application Publication
(10) Pub. No.: US 2014/0223568 A1
(43) Pub. Date: Aug. 7, 2014

(54) METHOD FOR SECURELY CHECKING A CODE

(71) Applicant: Eberhard Boehl, Reutlingen (DE)

(72) Inventor: Eberhard Boehl, Reutlingen (DE)

(21) Appl. No.: 14/131,117

(22) PCT Filed: Jun. 20, 2012
(86) PCT No.: PCT/EP2012/061769

§ 371 Date: Apr. 17, 2014

(30) Foreign Application Priority Data
Jul. 5, 2011 (DE) 10 2011 078 645.7

(51) Int. Cl. G06F 21/60

(52) U.S. Cl. CPC G06F 21/60
USPC 726/26

(57) ABSTRACT

A method and a circuit system are provided for securely checking a first code word. The method uses at least one code checker, and provides that the first code word to be checked is transferred into a second code word prior to entry into the code checker.

### FIELD OF THE INVENTION

The present invention relates to a method for securely checking a code and a circuit system for carrying out the presented method, also referred to as a tester or checker, which is secured against fault attacks.

### BACKGROUND INFORMATION

Redundant codes are used in safety-relevant systems in which, in the event of an error, the error is recognized by a code checker, thus allowing a critical situation to be averted. In this regard, m-out-of-n codes also play a role. In addition, for cryptographic applications, random generators which are to have a self-test at their disposal according to the recommendations of the National Institute of Standards and Technology (NIST) are necessary (also see the separate publication entitled “Recommendation for Random Number Generation Using Deterministic Random Bit Generators,” SP 800-90, March 2007). The implementation of a self-test for any given deterministic random generator may involve a high level of effort. When an m-out-of-n code is used for the implementation, the recommended self-test may be easily achieved using a code checker.

An m-out-of-n code is an error detection code having a code word length of n bits, each code word including exactly m instances of a “one.”

For generating an m-out-of-n code, for example a mask generator having m-out-of-n encoding may be used. One configuration of such a mask generator is illustrated in FIG. 1, for example, and is explained at an appropriate location herein.

Mask generators, similarly as for other cryptographic devices and cryptological algorithms, are subjected to attacks for the purpose of manipulating or reading out protected data. In encryption methods commonly used nowadays, such as the Advanced Encryption Standard (AES), keys are used which, due to the key length of 128 bits and greater, are not ascertainable by trial and error (so-called “brute force” attacks), even when rapid computational techniques are used. Therefore, an attacker also examines side effects of an implementation, such as the variation of power consumption over time, the duration, or the electromagnetic emission of a circuit in the encryption operation. Since the attacks do not directly target a function, they are referred to as side channel attacks.

These side channel attacks (SCA) make use of the physical implementation of a cryptosystem in a device. The control unit having cryptographic functions is observed during execution of the cryptological algorithms in order to find correlations between the observed data and the hypotheses for the secret key.

Numerous side channel attacks are believed to be understood, such as those discussed, for example, in the publication by Mangard, Oswald, and Popp in “Power Analysis Attacks,” Springer 2007. A successful attack on the secret key of the AES may be practicably carried out in particular by Differential Power Analysis (DPA).

In DPA, the power consumption of a microprocessor during cryptographic computations is recorded, and traces of the power consumption are compared to hypotheses, using statistical methods.

In known processes which make DPA more difficult, an intervention is made in the algorithm itself. With masking, the operations are carried out using randomly altered operands, and as a result the random value is then removed, which means that the random chance does not have an impact on the result. Another option is so-called hiding, in which an attempt is made to compensate for high-low transitions using corresponding low-high transitions.

As explained above, in the present state of the art of computational technology, recent cryptographic processes such as the Advanced Encryption Standard (AES) are well protected against so-called brute force attacks, i.e., testing all possibilities by trial and error, due to the length of the key and the complexity of the process itself. The attacks by a potential attacker are therefore increasingly focused on the implementations. Using so-called side channel attacks, the attacker attempts to obtain information concerning the power consumption during processing of the algorithm via the electromagnetic emission or the operand-dependent duration of the processing, via which the secret key may be deduced. However, if the secret key or the input/output signals of a cryptographic operation is/are linked to a mask that is unknown to the attacker, an attack is made more difficult or even prevented. The attacker will then initially attempt to find out the secret mask.

One option for improving the robustness against such side channel attacks is to use in a mask generator a system of automatic state machines or state machines having the same configuration, which are supplied with an input signal on the input side and which generate an output signal as a function of their state, each state machine always having a different state than the other state machines of the system. It is assumed that, due to the number of ones and zeros which is the same in each case (and thus a Hamming weight which is the same), and due to transitions of these states for identical input signals, each having the same Hamming distance, the power consumption is independent of the particular state of the state machines that are used.

It is known that so-called fault attacks may be used to bring a circuit into a state which is actually not provided for normal operation. This state provides an option for more easily ascertaining the secret key. Thus, for example, by a targeted alteration of the operating voltage (spike attacks), or by using electromagnetic fields or radiation, for example alpha particles or lasers, the state of individual or all used state machines could be changed into a state (0, 0, . . . , 0). If a bit vector generated in this way is used for masking a key, the originally provided protection of the key from side channel attacks is completely or at least partially lost. It is thus easier to ascertain the secret key. Using specialized code checkers, in particular for m-out-of-n code a check may be made very easily as to whether one or also multiple bits (in particular in one direction) has/have been corrupted.

Such code checkers are discussed, for example, in the publication by A. P. Stroele and S. Tarnick, entitled “Programmable Embedded Self-Testing Checkers for All-Unidirectional Error Detecting Codes,” Proceedings of the 17th IEEE VLSI Test Symposium, Dana Point, Calif., 1999, pages 361-369. The publication describes a code checker which monitors the outputs of a system in order to detect occurring errors as quickly as possible. The checker is composed of a number of full adders and flip-flops, and has a uniform structure. A simplified circuit for the same purpose is discussed in another publication by S. Tarnick, entitled “Design of Embedded Constant Weight Code Checkers Based on Averaging Operations,” Proceedings of the 16th IEEE On-Line Testing Symposium, Corfu Island, Greece 2010, pages 255-260.

The publication WO 2006/003023 A2 discusses a method and a system for recognizing unidirectional errors in words of systematic unordered code. This system also includes a number of full adders and flip-flops. The system, which includes a translation circuit and a Berger-type code checker, may be tested using a small number of code words.

The code checkers in the cited publications are configured in such a way that they test themselves. For this purpose, the code space is reduced, using a first checker, so that only one-half of the code bits are present, and also only one-half of the code bits have the value 1 (m/2 out of n/2). This procedure is carried out, for example, until a 1-out-of-2 code (dual-rail code) is present. However, this is valid only when m=n/2.

This dual-rail code is ultimately checked in a self-testing dual-rail code checker as described, for example, in the following article: S. Kundu, S. M. Reddy, “Embedded Totally Self-Checking Checkers: A Practical Design,” Design and Test of Computers, 1990, Volume 7, Edition 4, pages 5-12.

A disadvantage of known code checkers is that the code checkers themselves are not resistant to an attack, for example DPA. Regardless of whether or not a fault attack is present, an attacker could make use of the periods of the code check to draw conclusions concerning the secret key that is used.

### SUMMARY OF THE INVENTION

Against this background, a method for securely checking a code having the features described herein and a circuit system according to the description herein for carrying out the method are presented. Embodiments result from the dependent claims and the description.

Using the presented method, the risk of attacking a code checker with the aid of DPA is eliminated. The possibility is thus provided for continuously checking the state of a structure having 2ⁿ automatic state machines, each having n bits, for errors when all of these automatic state machines are configured to always have a different state. DPA is no longer able to make use of the testing itself. This allows the implementation of a DPA-resistant random generator according to NIST recommendations, for example in the publication NIST SP 800-90, in which a self-test of a deterministic random bit generator (DRGB) is required.

The method proposed herein, at least in some of the embodiments, goes far beyond the NIST requirements, which stipulate only a self-test. Due to the option for monitoring, significantly increased protection from fault attacks, for example, is ensured.

Further advantages and embodiments of the present invention result from the description and the appended drawings.

It is understood that the features stated above and to be explained below may be used not only in the particular stated combination, but also in other combinations or alone without departing from the scope of the present invention.

### BRIEF DESCRIPTION OF THE DRAWINGS

FIG. 1 shows one specific embodiment of a mask generator.

FIG. 2 shows a code reducer (weight averaging circuit) as the first stage of an 8-out-of-16 code checker.

FIG. 3 shows a three-stage code reducer for m-out-of-n code where m=8 and n=16.

FIG. 4 shows a two-rail code checker TRC.

FIG. 5 shows the formation of an error signal from the dual-rail signals from FIG. 3.

FIG. 6 shows a three-stage code reducer corresponding to the code reducer from FIG. 3 which is supplemented by a transfer unit.

FIG. 7 shows one embodiment of a transfer unit.

FIG. 8 shows one embodiment of the described method in a flow chart.

FIG. 9 shows another embodiment of the described method in a flow chart.

FIG. 10 shows a method step from FIG. 9 in greater detail.

FIG. 11 shows yet another embodiment of the described method in a flow chart.

FIG. 12 shows another embodiment of the described method in a flow chart.

FIG. 13 shows yet another embodiment of the described method in a flow chart. and

FIG. 14 shows an interchanging unit for cyclic codes.

### DETAILED DESCRIPTION

The present invention is schematically illustrated based on specific embodiments in the drawings, and is described in greater detail with reference to the drawings.

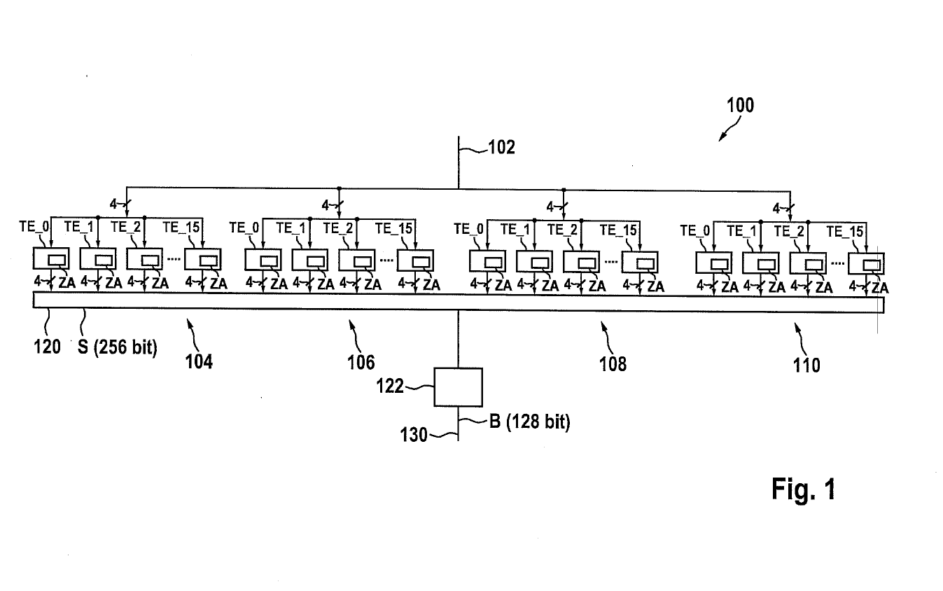

FIG. 1 schematically shows one specific embodiment of a mask generator which is denoted overall by reference numeral 100. This mask generator 100 is used for forming a bit vector having 128 bits from an input signal 102. For this purpose, circuit system 100 includes four systems 104, 106, 108, and 110, each having 16 transformation elements TE_{—}0, TE_{—}1, TE_{—}2, . . . , TE_{—}15. For the sake of clarity, only four of the 16 transformation elements TE_{—}0, TE_{—}1, TE_{—}2, . . . , TE_{—}15 are illustrated in FIG. 1. In this embodiment, mask generator 100 is configured in such a way that each transformation element TE_{—}0, TE_{—}1, TE_{—}2, . . . , TE_{—}15 of each of systems 104, 106, 108, and 110, respectively, is supplied with the same input data or the same input signal 102. It is important that in each system 104, 106, 108, 110 all transformation elements TE_{—}0, TE_{—}1, TE_{—}2, . . . , TE_{—}15 are connected to the input signals in the same way, but the various systems 104, 106, 108, and 110 may be different from one another.

Transformation elements TE_{—}0, TE_{—}1, TE_{—}2, . . . , TE_{—}15 form an output signal, not described in greater detail here, from input signal 102 supplied to them. These output signals are combined, and then receive a signature S 120 having 256 bits. Transformation elements TE_{—}0, TE_{—}1, TE_{—}2, . . . , TE_{—}15 each have an automatic state machine or a state machine ZA whose state information is stored, for example, in the form of a digital data word of predefinable width. For example, state machine ZA may have a memory capacity of 4 bits, so that a total of 16 different states are possible. State machines ZA of each system 104, 106, 108, 110 have the same configuration. The word “same” means that starting with identical input signals 102 and an identical initialization state, each state machine ZA assumes the same successor state as another identical state machine ZA in a subsequent processing cycle.

It is also provided that each state machine ZA in each case always has a different state than all other state machines ZA of corresponding systems 104, 106, 108, or 110. DPA attacks which attempt to draw conclusions concerning an internal processing state of circuit system 100 or of individual transformation elements TE_{—}0, TE_{—}1, TE_{—}2, . . . , TE_{—}15 based on an analysis of an electrical current and/or power consumption or of interference emissions are thus made more difficult.

It is advantageous when the number of provided transformation elements TE_{—}0, TE_{—}1, TE_{—}2, . . . , TE_{—}15 corresponds to the number of maximum possible different states of state machine ZA, in the present case, 16. As a result, every theoretically possible state is always present, i.e., for each processing cycle, in exactly one state machine ZA, so that in each case only one combination of all 16 possible states is “visible” from the outside, i.e., by a possible attacker carrying out a DPA attack. Even in a subsequent processing cycle, in which the individual state machines ZA each change their state according to a predefined rule, once again exactly one of the 16 possible states is present overall in each of the 16 state machines ZA, so that in turn all 16 states are simultaneously “visible” from the outside.

As a result, a possible attacker is not able to deduce a state of the internal signal processing in transformation elements. TE_{—}0, TE_{—}1, TE_{—}2, . . . , TE_{—}15 from a corresponding electromagnetic emission which is present in a customary implementation of circuit system 100, or also from the electrical power consumption of circuit system 100. For an ideally symmetrical configuration of all components, the electrical power consumption is always constant, so that the emitted electromagnetic field in each case experiences no significant changes during a change of state between successive processing cycles. Based on signature S 120, a bit vector 130 having 128 bits is generated by a linear gate in block 122. The linear gate may be an XOR gate or also an XNOR gate, for example. To further hinder the task of the potential attacker, the outputs of the various transformation elements are interchanged prior to the linear gate. One meaningful measure in this regard is to rotate the states within a system as a function of the input data.

Illustrated mask generator 100 utilizes so-called nonlinear signature formation. It is thus known how a structure based on p state machines having the same configuration and each having q state bits may be built whose power consumption is independent of the particular state of these state machines. For this purpose, a complete set of state machines (COSSMA) must be provided. This occurs precisely when p=2^{q}. If each state machine now has a different initial state, (p*q)/2 ones and the same number of zeros are thus necessarily present in the p*q bits. In addition, all of these state machines of such a system are provided with the same input signals. For a given input signal, if each of these state machines has a unique successor state and a unique precursor state, the states of the m state machines are different from one another at any time, and therefore this must necessarily involve a complete set of all possible states. Thus, a (p*q)/2-out-of-(p*q) code is present at any point in time of the processing of input data.

In one practical example, q=4 and therefore p=2⁴=16. The 16 state machines then always have the states 0, 1, 2, . . . , 15, and only the position of these states is arbitrary in alternation. When p*q=64, there are always exactly 32 ones and 32 zeros at the outputs of all of these state machines. This 32-out-of-64 code could be checked using a code checker as described above according to the related art. However, such a code checker would be very complex, since even in a first reduction stage in a circuit for a weighted average value formation for code reduction, a so-called weight averaging circuit WAC, 32 full adder cells, and also two flip-flops would be necessary. In the second stage, 16 full adders and two flip-flops would then be necessary, and so forth, until only two full adders and two flip-flops would be necessary. With 62 full adders (approximately 8 GE), 10 flip-flops (approximately 8 GE), and 6 dual-rail checkers (approximately 4 GE), a total outlay of approximately 600 gate equivalents (GE) would be necessary. If this were carried out for a 4-fold structure having 4*64 bits, a total of approximately 2400 gates of circuit complexity would be present in the parallel implementation.

In contrast, the presented implementation makes use of the fact that in the same bit positions of the state machines, the same number of ones is present at any point in time. Therefore, the checking may be subdivided, and in each case only 16 bits may be tested in a checking step. The remaining 3×16 bits are then tested in three further checking steps. In contrast to the code checkers provided according to the related art, the flip-flops upstream and downstream from the full adders may be completely dispensed with in the weight averaging circuit when a counter, which is present in the circuit anyway, is utilized and in each case one bit thereof is used on a weight averaging circuit WAC (code reducer), for example as input x₀. To implement the circuit with self-testing, the carry-in inputs of the weight averaging circuit and of the dual-rail checkers must assume all possible combinations at least once.

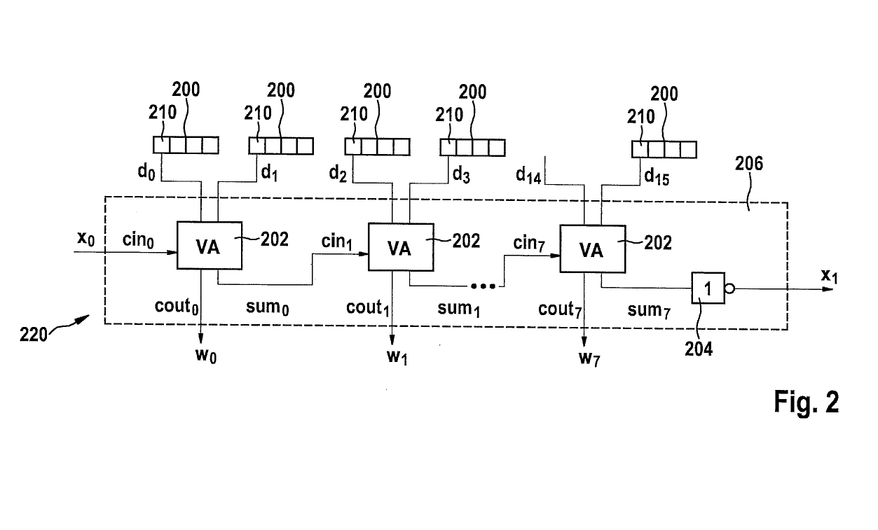

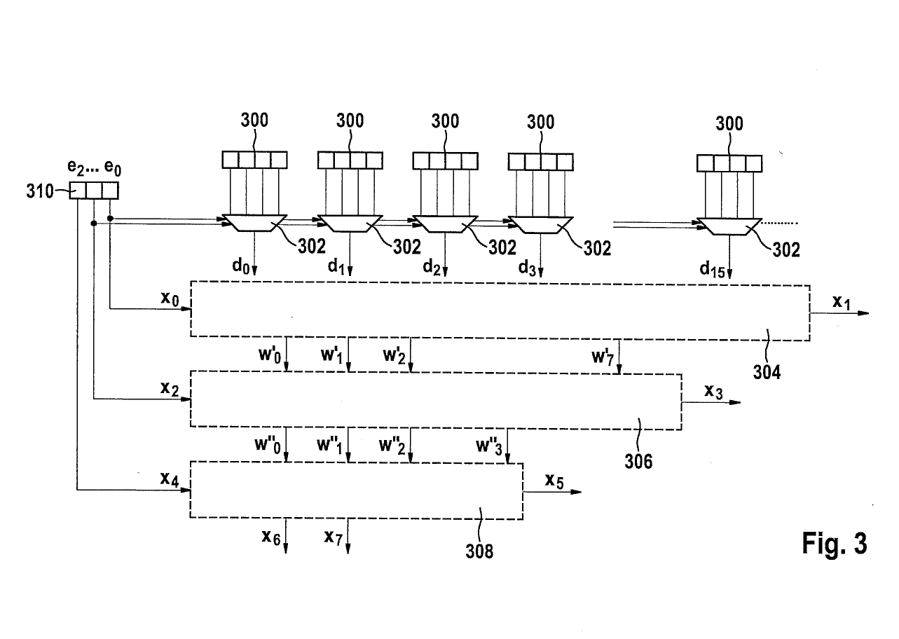

FIG. 2 shows such a weight averaging circuit (code reducer) WAC_{—}16 (without the flip-flops which are customary according to the related art) for 16 input bits d₀ . . . d₁₅. The illustration shows 16 state machines 200, each having five bits, of which four are depicted in this illustration. In addition, according to FIG. 2 eight full adders 202 are provided, of which only three are illustrated for the sake of clarity, and a NOT gate 204. A code reducer (WAC) 206 is shown with a dashed line border. The code reducer represents a stage 220 of a three-stage code reducer shown in FIG. 3, in which this stage is denoted by reference numeral 304.

The MSBs of the 16 state machines are used as input bits in this circuit. When the 16 state machines all have a different state, exactly 8 ones are contained in the 16 input bits (8-out-of-16 code). As disclosed in the literature according to the related art shown (Stroele, Tarnick), a 4-out-of-8 code is generated at the 8 outputs w′₀, w′₁, . . . w′₇ of 304 precisely when the input has been an 8-out-of-16 code and the reduction circuit contains no errors. Input x₀ generates an output x₁, where x₁≠x₀ when no error is present. Thus, a 1-out-of-2 code is present for this first signal pair. To ensure the quality of self-testing, x₀ must be changed frequently, and in addition d₀ . . . d₁₅ should not be constant either.

Sum bits of the full adders are denoted by sumₙ (n=0, 1, 2 . . . ), and transfer input bits of the full adders are denoted by cinₙ (n=0, 1, 2, . . . ). The transfer output bits (outputs of full adders 202), which are transferred into the next stage as signals wₙ (n=0, 1, 2 . . . ), are denoted by coutₙ (n=0, 1, 2 . . . ).

Lastly, FIG. 3 depicts a three-stage code reducer. The illustration once again shows state machines 300, each having four bits, a corresponding number of 4-to-1 multiplexers 302, a first WAC 304 (WAC_{—}16), a second WAC 306 (WAC_{—}8), and a third WAC 308 (WAC_{—}4), as well as a counter 310. In addition to the above-described signal pair x₀, x₁, signal pairs x₂, x₃ and x₄, x₅, which in the error-free case also correspond to a 1-out-of-2 code, are present at the respective other stages. These signal pairs are checked together with the reduced code. In the present case, a multistage code reducer is involved. The system illustrated in FIG. 3 may also be referred to as a system which includes three code reducers WAC 304 (WAC_{—}16), WAC 306 (WAC_{—}8), and WAC 308 (WAC_{—}4).

All 4-to-1 multiplexers 302 are controlled in the same way via counter bits e₀ and e₁, so that in each case they select the same position bit of state machine 300 as bit gᵢ. Thus, depending on the four states of these two counter bits, a given bit is selected in each case from one of the connected 16 state machines 300, which is then processed in code reducer or WAC_{—}16 304. In the error-free case, these inputs should correspond to an 8-out-of-16 code. The eight outputs w′₀ . . . w′₇ of WAC_{—}16 result in a 4-out-of-8 code and are connected to the inputs of WAC_{—}8 or code reducer 306. WAC_{—}8 306 has a similar configuration to WAC_{—}16 304, except that it has only half the number of full adders, and the last sum bit is connected to output x₃ in an inverted manner. Code reducer or WAC_{—}4 308 which is then additionally provided has only two full adders and two outputs, x₆ and x₇, to which the carry-out of these full adders is connected. Additional output x₅ is the inverted sum output of the second full adder in code reducer or WAC_{—}4 308.

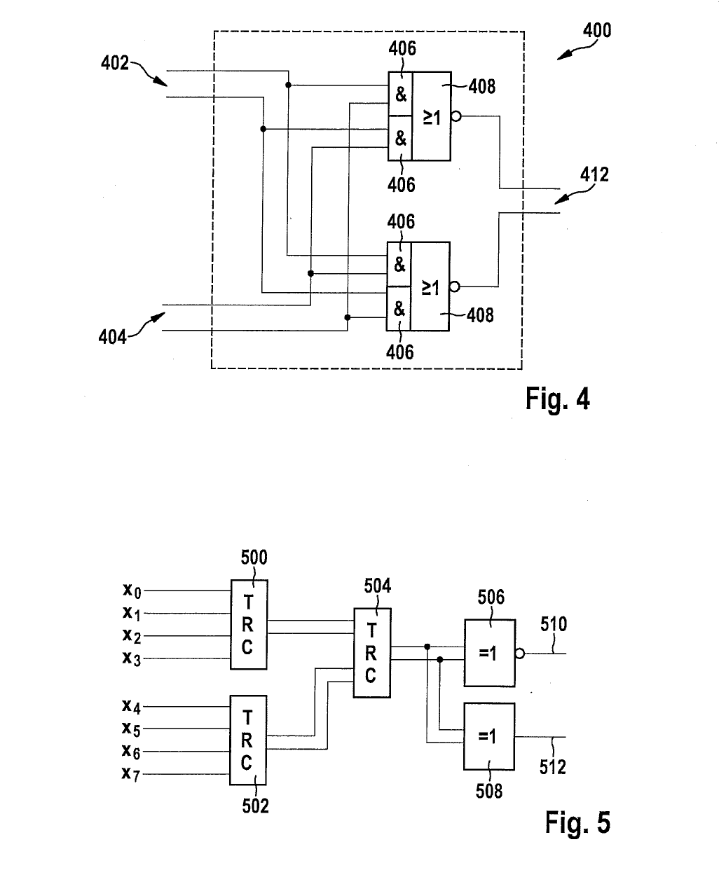

In the error-free case, respective pairs x₀ and x₁, x₂ and x₃, x₄ and x₅, and x₆ and x₇ in each case supply a dual-rail code (or 1-out-of-2 code); i.e., a signal of these pairs is always exactly 1. It is now sufficient only to test whether this property is fulfilled for all of these signal pairs. This check is carried out in so-called two-rail code checkers TRC according to FIG. 4.

e₂ . . . e₀ is an event counter which is incremented with each code check (in each case, 16 of the 64 bits are checked in four phases).

It is thus possible to check whether any of these automatic state machines has a different state at the point in time of the check, which indicates error-free functioning. In this method, however, it is possible for the check itself to allow conclusions concerning the secret states of the automatic state machine, for example by examining the power consumption of the code checker during the check. This is where the presented method comes into play.

FIG. 4 shows a code checker 400, in this case a two-rail checker TRC. This TRC 400 has a first input 402 and a second input 404. In addition, the illustration shows two complex gates, each of which links two different inputs twice via an AND element 406, and subsequently links and inverts the two outputs of these AND elements 406 via an OR element 408. The AND/OR and inversion elements may be implemented in a complex gate in such a way that they are inseparable, or may also be implemented as separate elements.

TRC 400 forms a dual-rail output signal at an output 412 from two dual-rail-coded signals at the two inputs 402 and 404. Output 412 is also formed as a dual-rail pair when the dual-rail code for both input signal pairs of inputs 402 and 404 are not impaired and TRC 400 itself operates in an error-free manner.

As shown in FIG. 5, the x signals of FIG. 3 in such TRCs may be combined to form a single dual-rail pair. The figure shows a first TRC 500, a second TRC 502, a third TRC 504, an equivalence element 506, and a nonequivalence element 508.

A code error is present when the two output signals of dual rail checker 504 are the same. The signal “error” 510 is equal to 1 and “not an error” 512 is equal to 0 as soon as the two outputs of 504 are the same. In the error-free case, 510 is equal to 0 and 512 is equal to 1. When input signals x₀, x₂, and x₄ assume any arbitrary combination, the TRCs are self-testing. This property is ensured by counter bits e₂ . . . eₒ when the counter counts from 0 to 7. The code of the counter is arbitrary (binary code, Gray code, excess 3 code, counting forward or backward) only when all allocated positions of the used bits occur in sequence. The signal “error” at output 510 of equivalence element 506 in FIG. 5 means either a code error or an error in the code checker itself. To recognize an error in equivalence element 506 itself (which outputs the error signal at an output 510), the signal/error is redundantly output to an output 512 via nonequivalence element 508 (XOR).

The code checker according to FIG. 5 in conjunction with FIG. 3 may now be used in the mask generator according to FIG. 1 (or in general, also in a random generator) as follows:
1. Checking takes place immediately in the input phase of 16 code bits in each case of a complete set of state machines (COSSMA) system, in the present example, 16 state machines each having 4 bits. Due to this parallel checking, in each case 16 of the 64 bits of a COSSMA system may be checked for each input vector or input signal 102 during the generation of the mask. After four cycles, in each case the entire COSSMA system is checked. If errors appear, the further mask generation is terminated. This prevents an attacker from being able to observe a current profile of the disturbed circuit which is changed by an infiltrated error. However, the self-test circuit itself must be prevented from allowing an attacker further opportunities for an attack. This is made more difficult in particular due to the fact that the attacker must establish hypotheses for all bits of the initial state of a COSSMA. Since the input bits on all state machines of a COSSMA system act in the same way, an attack on individual state bits is not likely to succeed.
2. Checking after rotation is carried out. This variant has the advantage that the individual state machines on average depend on all bits of the initial state of a COSSMA. In addition, this method has the advantage that an error infiltrated only after the rotation was recognized, and the generation of a mask is then also still prevented. A disadvantage is that errors which have infiltrated in the input phase are not recognized, and the altered current pattern may then possibly be utilized by an attacker.
3. A combination of 1 and 2: The COSSMAs are continuously monitored for 16 bits in each case.

The proposed circuit requires 14 full adders (8 GE each), 3 inverters (0.5 GE each), 16×4:1 multiplexers (7.5 GE each), 3 TRCs (4 GE each), and 2 XOR/XNOR (2.5 GE each). This is approximately 250 GE total, and thus significantly less than the above-mentioned recommendation of 600 GE. For 4 COSSMA structures, either 4×250=1000 GE are necessary, or the operation for the four structures is carried out successively on the same hardware and additionally requires 64×4:1 multiplexers having 480 GE, i.e., approximately 750 GE total.

In a generalization of the method, other codes which do not satisfy the condition m=n/2 may also be checked.

For the case that m≠n/2, the m-out-of-n code cannot be reduced to two bits via multiple stages as in FIG. 2 (x₆ and x₇). If m=4 and n=16, for example, only two stages are possible in the manner shown. Outputs w″₀ . . . w″₃ then form a 1-out-of-4 code which may be checked using customary code checkers and which supplies a dual-rail output.

If m=2 and n=16, it is possible to carry out only the first stage according to FIG. 2. The code at outputs w′₀ . . . w′₇ is an 1-out-of-8 code which likewise may be checked using customary code checkers and which supplies a dual-rail output.

These dual-rail outputs of the customary code checkers are checked in the TRCs according to FIG. 4 together with the other dual-rail signal pairs.

Thus, a circuit system for checking an m-out-of-n code using a multistage code reducer is described which is suited in particular for carrying out the presented method, at least one stage of this code checker being composed of multiple full adders, and in the first stage n/2 full adders being used in which the sum bit of a full adder in each case is led to the transfer input of the next full adder, and the n/2 transfer bits are output to the n/2 full adders. In addition, it may be provided that the transfer input of the first full adder is connected to the output of a first counter bit, and the sum output of the last full adder is output, and that the first counter bit and the sum bit of the last full adder form a first signal pair.

Furthermore, it may be provided that the second stage of the code checker is composed of n/4 full adders, and that the n/2 output bits of the first stage are connected to the operand inputs of the n/4 full adders of the second stage of the code checker, the sum bits of the full adders in each case being connected to the transfer input of the next full adder, and the n/4 transfer bits being output to the n/4 full adders, a second counter bit being connected to the transfer input of the first full adder of the second stage, and this second counter bit together with the output sum bit of the last full adder of the second stage forming a second signal pair.

In addition, further stages of the code checker may be added, provided that up to only two transfer bits of two full adders which form a dual-rail signal pair (for m=n/2) may be output, or another suitable code checker is connected to one of the stages (for m≠n/2), and for the last stage, for the case that m=n/2, either a last signal pair is formed from the connected last counter bit and the sum output of the second full adder, or a code checker checks the code of the preceding stage and outputs a dual-rail signal pair.

For the signal pairs (first, second, . . . last), in each case a signal may be inverted, and modified signal pairs may thus be formed. These modified signal pairs together with the dual-rail signal pair, connected to one another, are led to a two-rail checker in such a way that a last two-rail checker outputs a signal pair which forms a 1-out-of-2 code when the code and the code checker are free of errors, and therefore a check may be made for errors in the m-out-of-n code or in the test circuit itself.

The mentioned counter bits may be varied in such a way that all states of these counter bits are incorporated during successive checking steps (of one or multiple code words), and that various code words may be selected for checking, using various counter bits.

In addition, the m-out-of-n code to be checked may be split into multiple subcodes. These subcodes may be successively checked on the same code reducer or code checker. For this purpose, the inputs of the code reducer may be switched between the various subcodes.

Alternatively, these subcodes may be simultaneously checked on different code reducers.

Thus, FIG. 2 shows the possible configuration of the first stage of the code checker. Lastly, FIG. 3 shows a three-stage code reducer. In the error-free case, respective pairs x₀ and x₁, x₂ and x₃, x₄ and x₅, and x₆ and x₇ in each case supply a dual-rail code or a 1-out-of-2 code; i.e., exactly one signal of these pairs is 1. This is checked using the code checkers according to FIGS. 4 and 5. In the error-free case, the signal/error is a 0 at output 510 from FIG. 5, and the signal/error is a 1 at output 512.

Even in the first stage of code reducer 206 according to FIG. 2, it is apparent that, for example, output w₀ is exactly 1 when both d₀ and d₁ are equal to 1. Thus, an attack on signal w₀ allows conclusions concerning corresponding input signals d₀ and d₁. As a result, the complete secret state of all automatic state machines is possibly ascertainable.

The presented method is now based on intermixing and interchanging the input signals in an unpredictable manner. This is possible due to the fact that the code checker delivers the same result, regardless of the sequence of the input signals.

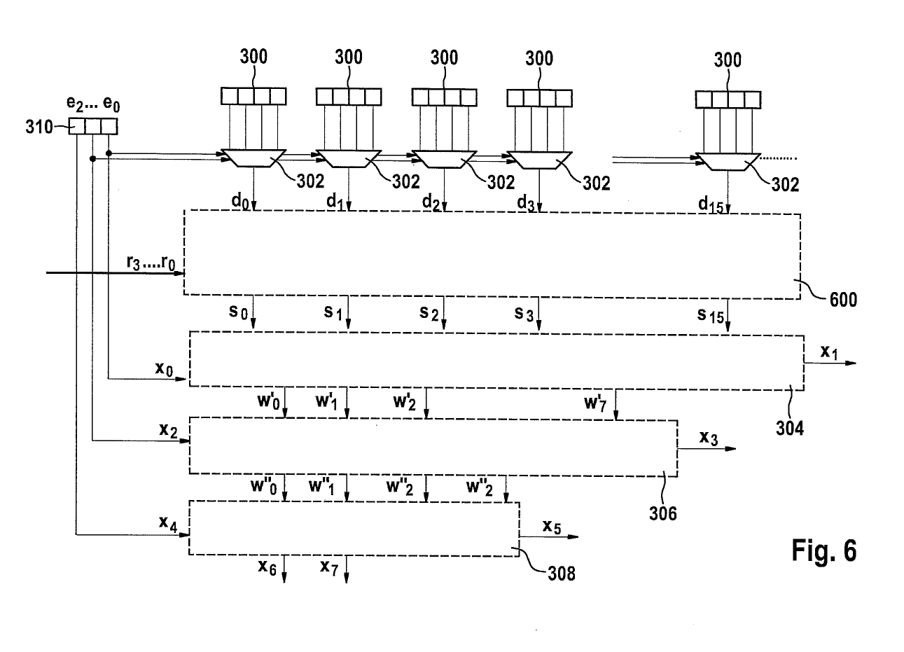

FIG. 6 shows a three-stage code reducer corresponding to the code reducer from FIG. 3, which is configured for secure operation. For this purpose, a transfer unit 600 is provided which is inserted between state machines 300 and first stage 304 of the code reducer. This transfer unit 600 requires four nonpredictable input bits r₀ through r₃, so-called entropy bits, which may be obtained, for example, from an A/D converter (LSBs) of a physical variable or a ring oscillator. However, other options for generating the entropy bits are also conceivable. The entropy bits typically have no influence on the result of the check.

In this way it is ensured that the position of the code bits, and thus the possibly secret precursor stage, cannot be deduced by successfully analyzing the current pattern during decoding.

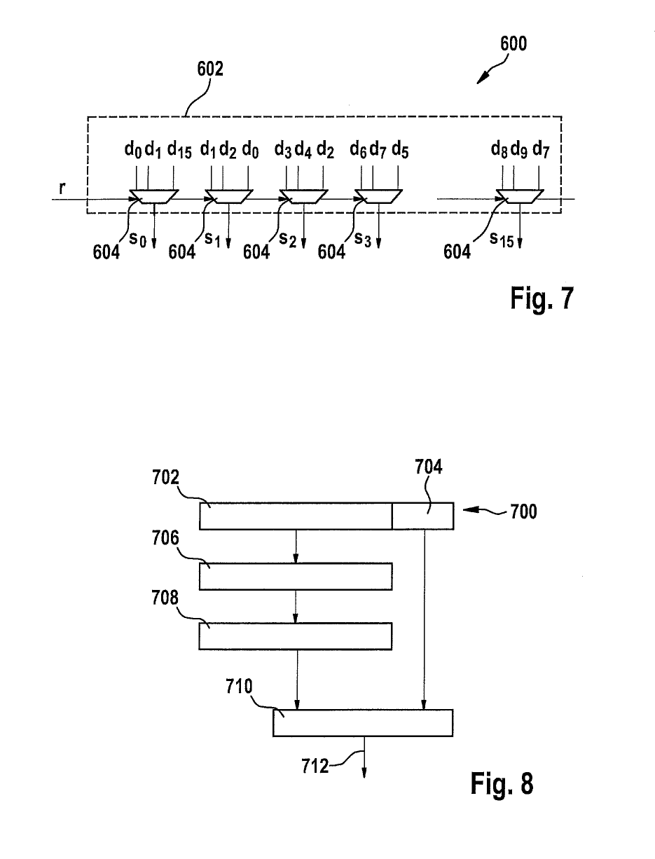

FIG. 7 shows transfer unit 600 from FIG. 6 in a more detailed view. It is apparent that transfer unit 600 is configured as a multiple multiplexer 602 which in turn includes a number of multiplexers 604. In this case, transfer unit 600 is thus configured as an interchanging unit which interchanges the position of the bits in the code word. This is possible whenever a valid code word once again results from interchanging the bits of a valid code word. As one possible alternative, the transfer unit may also be configured to add additional bits into the code word to be checked. It should be ensured that the code word to be checked is transferred into another code word. The illustration shows how bits s₀ through s₁₅ are obtained from bits d₀ through d₁₅ using multiple multiplexer 602. Input signals d₀ through d₁₅ of multiple multiplexer 602 are connected to outputs s₀ through s₁₅ via multiplexers 604, depending on the state of entropy bits r₀ through r₃. When the allocated positions of bits r₃ through r₀ are represented by values 0 . . . 15 of r (decimal equivalent of these bits), for r=0, bits d₀ through d₁₅ are connected to bits s₀ through s₁₅ in such a way that the spacing is incremented by 1 in each case with increasing bit value. The interchanging is carried out cyclically, for example, so that a start is made once again with d₀ when value d₁₅ is exceeded. For r=1, bits s₀ through s₁₄ are similarly assigned, except that a start is made with bit d₁. For r=2, a start is made with d₂, and so forth.

It is thus ensured that for any value of r, other combinations of proximity relationships in s₀ through s₁₅ result, and therefore in each case other signals are also entered in an adder of structure WAC_{—}16.

The intermixing also acts indirectly on the proximities of the subsequent stages. Since the signals of r are not predictable and are not known to a potential attacker, the attacker is therefore also not able to carry out attacks on the output signals of the code checker stages or their internal intermediate signals. The proposed shifts are listed in Table 1 below. However, any other desired associations are also possible when in each case all bits d₀ through d₁₅ are present in bits s₀ through s₁₅ for any value of r.

TABLE 1

| r | s0 | s1 | s2 | s3 | s4 | s5 | s6 | s7 | s8 | s9 | s10 | s11 | s12 | s13 | s14 | s15 |
|---|---|---|---|---|---|---|---|---|---|---|---|---|---|---|---|---|
| 0 | d0 | d1 | d3 | d6 | d10 | d15 | d5 | d12 | d4 | d13 | d7 | d2 | d14 | d11 | d9 | d8 |
| 1 | d1 | d2 | d4 | d7 | d11 | d0 | d6 | d13 | d5 | d14 | d8 | d3 | d15 | d12 | d10 | d9 |
| 2 | d2 | d3 | d5 | d8 | d12 | d1 | d7 | d14 | d6 | d15 | d9 | d4 | d0 | d13 | d11 | d10 |
| 3 | d3 | d4 | d6 | d9 | d13 | d2 | d8 | d15 | d7 | d0 | d10 | d5 | d1 | d14 | d12 | d11 |
| 4 | d4 | d5 | d7 | d10 | d14 | d3 | d9 | d0 | d8 | d1 | d11 | d6 | d2 | d15 | d13 | d12 |
| 5 | d5 | d6 | d8 | d11 | d15 | d4 | d10 | d1 | d9 | d2 | d12 | d7 | d3 | d0 | d14 | d13 |
| 6 | d6 | d7 | d9 | d12 | d0 | d5 | d11 | d2 | d10 | d3 | d13 | d8 | d4 | d1 | d15 | d14 |
| 7 | d7 | d8 | d10 | d13 | d1 | d6 | d12 | d3 | d11 | d4 | d14 | d9 | d5 | d2 | d0 | d15 |
| 8 | d8 | d9 | d11 | d14 | d2 | d7 | d13 | d4 | d12 | d5 | d15 | d10 | d6 | d3 | d1 | d0 |
| 9 | d9 | d10 | d12 | d15 | d3 | d8 | d14 | d5 | d13 | d6 | d0 | d11 | d7 | d4 | d2 | d1 |
| 10 | d10 | d11 | d13 | d0 | d4 | d9 | d15 | d6 | d14 | d7 | d1 | d12 | d8 | d5 | d3 | d2 |
| 11 | d11 | d12 | d14 | d1 | d5 | d10 | d0 | d7 | d15 | d8 | d2 | d13 | d9 | d6 | d4 | d3 |
| 12 | d12 | d13 | d15 | d2 | d6 | d11 | d1 | d8 | d0 | d9 | d3 | d14 | d10 | d7 | d5 | d4 |
| 13 | d13 | d14 | d0 | d3 | d7 | d12 | d2 | d9 | d1 | d10 | d4 | d15 | d11 | d8 | d6 | d5 |
| 14 | d14 | d15 | d1 | d4 | d8 | d13 | d3 | d10 | d2 | d11 | d5 | d0 | d12 | d9 | d7 | d6 |
| 15 | d15 | d0 | d2 | d5 | d9 | d14 | d4 | d11 | d3 | d12 | d6 | d1 | d13 | d10 | d8 | d7 |

Association of Input Bits d₀ . . . d₁₅ with Output Bits s₀ . . . s₁₅ as a Function of r

The presented method is usable in principle in all deterministic random bit generators which are based, for example, on a COSSMA and are therefore inured to DPA attacks. In particular, the method may be used with nonsystematic codes. However, use with systematic codes is also conceivable when it is ensured that only the information bits are interchanged.

Thus, the method is also usable for a Berger code, for example, when only the information bits and not the check bits are interchanged in an appropriate manner. For a Berger code, the check bits represent the number of ones (binarily represented and inverted) in the information bits. When the information bits are interchanged, the number of ones at that location remains the same. Accordingly, for this code the check may also be carried out with interchanged information bits.

For a parity code which is a systematic code, a check is made as to whether the number of ones, including the parity bit, is even or odd. Here as well, the sequence does not play a role. The bits for the parity check may be arbitrarily interchanged, and the parity bit may also be included in this interchange.

For a Hamming code, although the position of the bits does not play a role, when the code check is considered as a sum of parity checks, for each parity check the bits considered in the parity check may be arbitrarily interchanged prior to the code checker. In this case, however, the parity bit is preferably not included in the interchange when an error correction is to be made, since the parity bits include information concerning the bit streams to be corrected. For security reasons (for prevention of fault attacks), however, a correction is not very meaningful. Thus, if a Hamming code is to be used only for recognizing multiple errors without correction, the interchange for each parity check, including a parity bit, is thus possible. It should be ensured that some of the bits of the code word are included in multiple parity checks. These bits are then interchanged, possibly in a different way, for each of these checks.

In this sense, code checkers for the self-test measures mentioned at the outset for a DRGB code are meaningfully usable with m-out-of-n code, Berger Code, parity code, and Hamming code, and the code check itself is not attackable via DPA.

One possible procedure for a Berger code is illustrated in a flow chart in FIG. 8. A first code word 700 to be checked includes information bits 702 and check bits 704. Information bits 702 are interchanged in an interchanging unit 706. This results in a second code word. Check bit generation takes place in a next step 708 in which the ones are counted, and the result is binarily represented and inverted. A comparison of the result from step 708 to check bits 704 is then also carried out in a comparator unit 710. A corresponding result is output to output 712.

Secure checking is made possible by interchanging information bits 702 in interchanging unit 706, i.e., prior to the actual check.

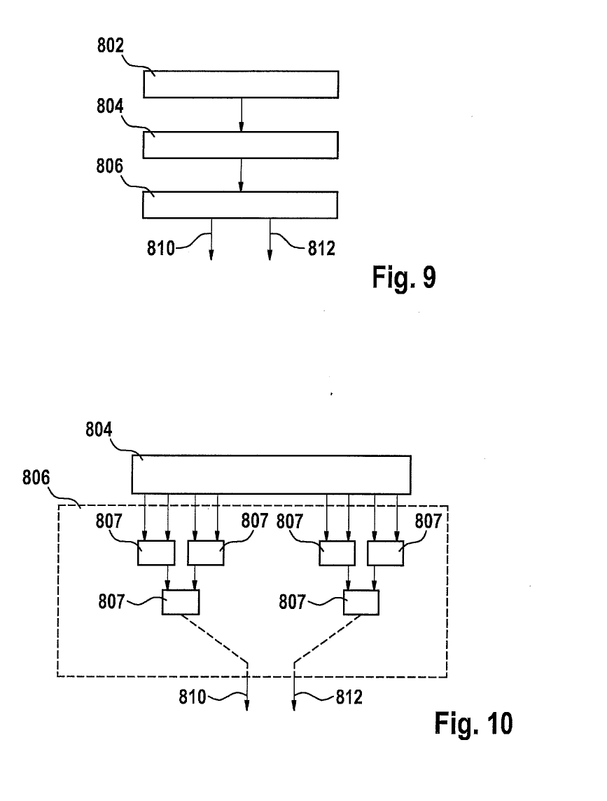

FIG. 9 illustrates one possible sequence for a parity code. First code word 802 to be checked includes information bits and an associated parity bit. All bits of first code word 802 are interchanged in an interchanging unit 804. The check as to whether the total number of ones is even or odd takes place in a parity code checker 806. A first output 810 and a second output 812 output a dual rail code, and one of the two outputs is inverted if necessary.

FIG. 10 depicts the checking from FIG. 9 in greater detail. The illustration shows interchanging unit 804, parity code checker 806, first output 810, and second output 812. Parity code checker 806 includes six XOR elements 807 which are divided into two trees. For even parity, one of the two signals delivered via outputs 810, 812 is inverted.

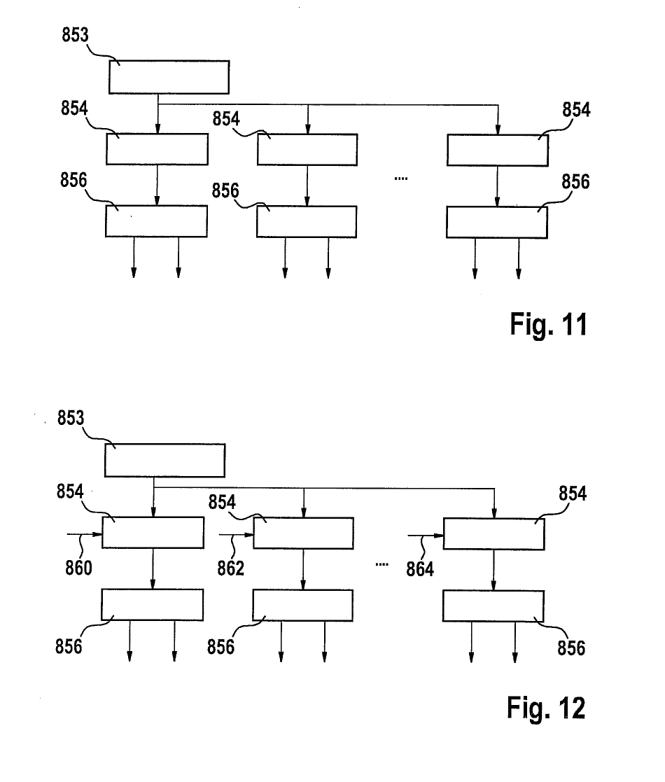

FIG. 11 shows one possible sequence for a Hamming code. A first code word 853 to be checked includes information bits together with multiple parity bits. In addition, a number of interchanging units 854 are illustrated, of which three are shown in this illustration. Each of these interchanging units 854 is provided for selective information bits and an associated parity bit. In addition, the illustration shows parity code checkers 856, each of which outputs dual rail codes.

A modified embodiment for a Hamming code is illustrated in FIG. 12. In this embodiment, different nonpredictable bits, i.e., entropy bits 860, 862, and 864, are associated with each interchanging unit 856. This means that the various interchanging units 856 interchange as a function of different nonpredictable bits 860, 862, and 864.

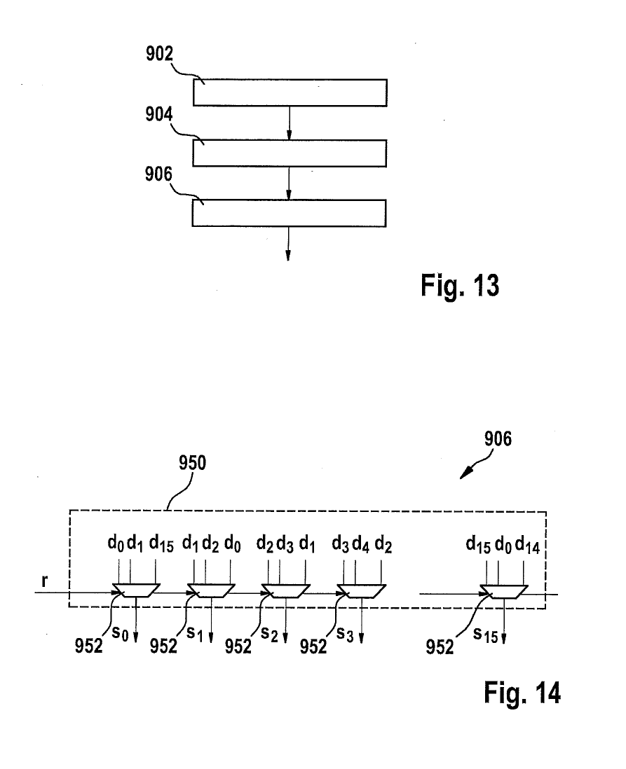

FIG. 13 illustrates another sequence for a cyclic code 902 which includes information bits and check bits. This first code word 902 to be checked is input into an interchanging unit 904, which in this case carries out a cyclic interchange. The resulting second code word is input into a code checker 906.

FIG. 14 explains interchanging unit 906 from FIG. 13. This interchanging unit is configured as a multiple multiplexer 950 having 16 multiplexers 952, of which five are shown in this illustration. Examples of cyclic codes include Bose-Chaudhuri-Hocquenghem (BCH) codes, Golay codes, Fire codes, quadratic residue codes, Goppa codes, and CCITT codes.

The cyclic interchange may also be used for all of the above-described interchange operations. Provided that multiple multiplexer 602 illustrated in FIG. 7 may be utilized, this multiple multiplexer should preferably be used, since the sequence of the bits may be varied in this multiple multiplexer, and therefore the observability with DPA is decreased even more.

The cyclic interchanging according to FIG. 14 is illustrated in Table 2 below.

TABLE 2

| r | s0 | s1 | s2 | s3 | s4 | s5 | s6 | s7 | s8 | s9 | s10 | s11 | s12 | s13 | s14 | s15 |
|---|---|---|---|---|---|---|---|---|---|---|---|---|---|---|---|---|
| 0 | d0 | d1 | d2 | d3 | d4 | d5 | d6 | d7 | d8 | d9 | d10 | d11 | d12 | d13 | d14 | d15 |
| 1 | d15 | d0 | d1 | d2 | d3 | d4 | d5 | d6 | d7 | d8 | d9 | d10 | d11 | d12 | d13 | d14 |
| 2 | d14 | d15 | d0 | d1 | d2 | d3 | d4 | d5 | d6 | d7 | d8 | d9 | d10 | d11 | d12 | d13 |
| 3 | d13 | d14 | d15 | d0 | d1 | d2 | d3 | d4 | d5 | d6 | d7 | d8 | d9 | d10 | d11 | d12 |
| 4 | d12 | d13 | d14 | d15 | d0 | d1 | d2 | d3 | d4 | d5 | d6 | d7 | d8 | d9 | d10 | d11 |
| 5 | d11 | d12 | d13 | d14 | d15 | d0 | d1 | d2 | d3 | d4 | d5 | d6 | d7 | d8 | d9 | d10 |
| 6 | d10 | d11 | d12 | d13 | d14 | d15 | d0 | d1 | d2 | d3 | d4 | d5 | d6 | d7 | d8 | d9 |
| 7 | d9 | d10 | d11 | d12 | d13 | d14 | d15 | d0 | d1 | d2 | d3 | d4 | d5 | d6 | d7 | d8 |
| 8 | d8 | d9 | d10 | d11 | d12 | d13 | d14 | d15 | d0 | d1 | d2 | d3 | d4 | d5 | d6 | d7 |
| 9 | d7 | d8 | d9 | d10 | d11 | d12 | d13 | d14 | d15 | d0 | d1 | d2 | d3 | d4 | d5 | d6 |
| 10 | d6 | d7 | d8 | d9 | d10 | d11 | d12 | d13 | d14 | d15 | d0 | d1 | d2 | d3 | d4 | d5 |
| 11 | d5 | d6 | d7 | d8 | d9 | d10 | d11 | d12 | d13 | d14 | d15 | d0 | d1 | d2 | d3 | d4 |
| 12 | d4 | d5 | d6 | d7 | d8 | d9 | d10 | d11 | d12 | d13 | d14 | d15 | d0 | d1 | d2 | d3 |
| 13 | d3 | d4 | d5 | d6 | d7 | d8 | d9 | d10 | d11 | d12 | d13 | d14 | d15 | d0 | d1 | d2 |
| 14 | d2 | d3 | d4 | d5 | d6 | d7 | d8 | d9 | d10 | d11 | d12 | d13 | d14 | d15 | d0 | d1 |
| 15 | d1 | d2 | d3 | d4 | d5 | d6 | d7 | d8 | d9 | d10 | d11 | d12 | d13 | d14 | d15 | d0 |

### Association of the Bits in Cyclic Interchanging

As already mentioned in the preceding embodiments, bits may also be added to a code word in the transfer unit. This is possible whenever a valid code word thus once again results. Thus, for a 4-out-of-8 code, for example, four ones and four zeros may be added to the code word at any arbitrary position. The resulting code word is then an 8-out-of-16 code word. For a parity code word, any arbitrary number of zeros and an even number of ones may be added, and a valid code word having a correspondingly increased bit width is obtained. For a Berger code, any arbitrary number of zeros may be added in the information part.

The above-described examples show options via which the observation of the current pattern may be made more difficult for an attacker by increasing the bit width of the code word, since the attacker is not able to distinguish between the original bits of the original code word and the additionally added bits (dummy bits). Adding code bits may take place in addition to the interchanging. Furthermore, the additionally added bits may also be interchanged, or their position should be determined as a function of nonpredictable bits.

In principle, the first code word may be transferred into at least one second code word; i.e., a transfer may be made into exactly one second code word or into a number of second code words.

1-10. (canceled)

11. A method for securely checking a first code word, the method comprising:
using at least one code checker;
transferring the first code word to be checked into at least one second code word with the aid of a transfer unit prior to input into the at least one code checker; and
checking the second code word using the code checker.

12. The method of claim 11, wherein the bits of the first code word to be checked are interchanged.

13. The method of claim 12, wherein the bits of the first code word to be checked are interchanged using at least one multiplexer.

14. The method of claim 11, wherein the first code word to be checked is modified in the transfer unit by adding additional bits.

15. The method of claim 11, wherein the transfer unit transfers as a function of nonpredictable bits.

16. The method of claim 11, wherein at least one code reducer is associated with the code checker.

17. A circuit system for securely checking a first code word using at least one code checker, comprising:
a transfer unit via which the first code word to be checked is to be transferred into at least one second code word prior to input into the at least one code checker.

18. The circuit system of claim 17, wherein the transfer unit includes an interchanging unit, which is configured to interchange the bits of the first code word for forming a second code word.

19. The circuit system of claim 18, wherein the interchanging unit includes at least one multiplexer.

20. The circuit system of claim 17, wherein the transfer unit is configured to add these additional bits into the first code word and to determine the position of these additional bits in the second code word and/or the position of the bits of the first code word in the second code word, using nonpredictable bits.
